(19) United States
(12) Patent Application Publication
(10) Pub. No.: US 2002/0173979 A1
(43) Pub. Date: Nov. 21, 2002

(54) GPS-based system related to verifiable carbon credits

(76) Inventors: Dennis G. Daggett, Winterset, IA (US); James K. Petersen, Winterset, IA (US); Gregory A. Livingston, Winterset, IA (US); John E. Sheeley, West Des Moines, IA (US); Brian T. Donoho, Urbandale, IA (US); John K. McGillicuddy, Clive, IA (US); Steven C. Griffin, West Des Moines, IA (US)

Correspondence Address: Michael C. Gilchrist, Dorsey & Whitney LLP, 801 Grand Avenue, Des Moines, IA, 50309, US

(21) Appl. No.: 09/860,860

(22) Filed: May 18, 2001

(51) Int. Cl. G06F 17/60

(52) U.S. Cl. 705/1

(57) ABSTRACT

A system for gathering and organizing land-related information by associating that information with GPS coordinates. The system maps an agricultural field and divides the map of the field into management zones. The boundaries of the field and management zones are defined by Geographic Positioning System (GPS) coordinates. A Geographic Information System (GIS) record is created with respect to each management zone and fields of relevant agronomic information for that management zone are associated with the record. The GIS records associated with the system are useful in verifying Carbon credits (carbon credits), and the mechanisms used to gather the information for the GIS records is useful for accumulating carbon credits.

### BACKGROUND

This invention relates generally to methods for soliciting, accumulating, and verifying the existence of carbon credits. More specifically, it relates to a system for making carbon credits verifiable by associating the carbon credits with GPS coordinates that are used to define the boundary of the land on which the carbon credits were created, thereby assuring that carbon credits from the same land cannot be oversold.

Farms that practice land-friendly practices such as no-till or reduced tillage farming have an overall reduced risk of crop failure. Therefore, it is desirable to encourage these practices. These practices also have the added benefit of removing carbon dioxide from the atmosphere and sequestering it in the soil, so that the soil acts as a carbon storage device, sometimes referred to as a carbon sink. One possible incentive for farmers to convert to these land-friendly practices is a system of carbon credits (carbon credits) associated with a reduction in carbon dioxide emissions or a removal of carbon dioxide from the atmosphere. In some literature these carbon credits are referred to carbon emission reduction credits or CERCs.

According to a carbon credit system, a person or entity is awarded carbon credits to recognize actions taken that reduce the overall emission of specified greenhouse gases such as carbon dioxide. An important feature of this carbon credit system is that the carbon credits may be bought and sold in an open market, which is currently being established. These markets can be created by regulation or through voluntary efforts.

By allowing the carbon credits to be bought and sold, an incentive to reduce overall emissions is created. Regulations may be implemented which would require a party to offset any new or increased emissions with carbon credits that were either created by that entity, or purchased from a third party. Once a carbon credit is created, it remains in existence until it is redeemed or retired. A carbon credit is redeemed when it is used to offset an increase in emissions, for example by an emission source that wishes to increase its emissions, or by a source that must reduce its emissions, but cannot do so through any economically or technically feasible means. A carbon credit is retired when it is permanently taken off the market in order to reduce the overall amount of emissions, for example by an environmental group willing to pay for the reduction in emissions.

The soil has a great capacity for storing greenhouse gases such as carbon dioxide. If farmers were able to sell the carbon credits, it would create an incentive to use these practices, which should lead to a reduction in greenhouse gases and a reduced risk to insurance providers. In order to create a viable market for carbon credits it is necessary to create a system that is verifiable and that does not create large administrative costs.

Presently, sulfur dioxide is regulated in a manner that permits its emissions allowances to be bought and sold on the open market. The Chicago Board of Trade conducts auctions transferring ownership of sulfur dioxide emission allowances. There have been a few spot trades in carbon credits; however, to date there is no established market. Because of the intangible nature of carbon credits, one of the difficulties of a carbon credit market is verifiability. There must be some way of verifying that the carbon storage capacity of the same land has not been sold more than once.

Global Positioning Systems (GPS) are systems that utilizes satellites placed in orbit by the United States Government to locate with a unique set of coordinates any place on earth. With the use of a receiver that is adapted to receive and translate signals from these satellites, the location of any place on earth can be determined with a great deal of accuracy, and defined according to a set of coordinates. The coordinates are global in nature so that no two places can share the same coordinates. A Geographic Information System (GIS) is an electronic system that store and manipulate GPS coordinates data. Applicants are aware of no existing systems that utilize GPS data or GIS systems to solve the above described needs.

In summary, a need exists for a verifiable system that encourages the creation of a market for carbon credits.

The system and methods described in the present application meet these needs by proposing a GPS-based system for assimilating all relevant information related to a piece of land

### SUMMARY OF THE INVENTION

One feature of the invention is that it permits the recording of verifiable carbon credits. This is accomplished by determining the amount of carbon credits that have been or will be created on a parcel of land, defining a boundary for the parcel of land in terms of GPS coordinates, and creating an electronic GIS record based the GPS coordinates that associates the carbon credits created on the parcel of land with the GPS coordinates that define the parcel of land.

According to a second feature of the present invention information necessary to establish verifiable carbon credits is accumulated. This accumulation of information includes the step of reaching an agreement with a landowner to accumulate data relevant to establishing a carbon credit for activities conducted on a parcel of land owned by the landowner. The boundary of the landowner's parcel of land is defined in terms of GPS coordinates. The data necessary to establish the existence of a carbon credit is collected and entered into a GIS system that associates the data with the GPS coordinates of the parcel of land.

According to another feature of the present invention the existence of carbon credits are verified for third parties. The third party specifies a parcel of land for which it would like to verify the existence of carbon credits. The relevant GPS coordinates of the specified parcel of land are determined, and compared to an existing data base of carbon credits associated with the GPS coordinates of the land on which they were created to verify that the specified parcel of land does not include any area for which carbon credits have already been sold. Additionally, a physical inspection of the specified parcel of land may be conducted to determine whether the practices necessary to create the carbon credits are being conducted on the specified parcel.

### BRIEF DESCRIPTION OF THE DRAWINGS

FIG. 1 is a map showing a parcel of land mapped to indicate soil types.

FIG. 2 is an input screen from a computer showing a parcel of land subdivided into management zones.

FIG. 3 is a flow chart illustrating a preferred method of carbon credits solicitation.

FIG. 4 is a flow chart illustrating a preferred flow of documents in the carbon credits solicitation method of the present invention.

FIG. 5 is an example of a Summary of Potential Carbon credit Form according to the present invention.

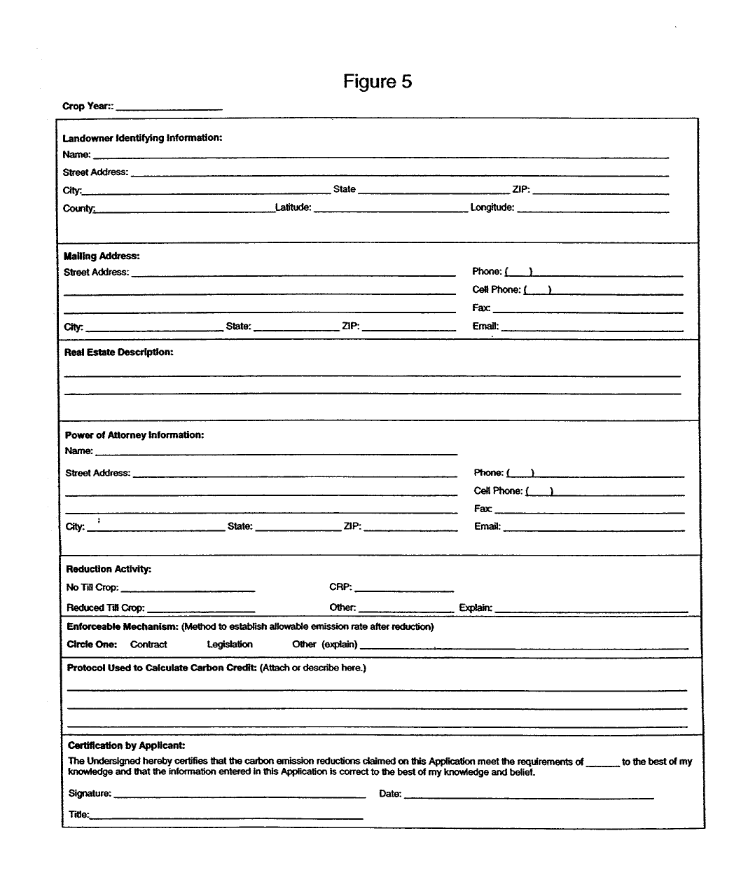

### DETAILED DESCRIPTION OF PREFERRED EMBODIMENTS

Described herein is an overall process for gathering agronomic information, associating that information with GPS coordinates, and using the information associated with the GPS coordinates to provide a basis for identification, solicitation, documentation, verification, and marketing of carbon credits.

The overall profitability of an insurer, or other user of the system, may be improved by generating revenue through the sale of services related to the administration of the accumulation and verification of carbon credits.

As an overview, the components of the invention might be generally described as: creating a map that divides a parcel of land, or field, into management zones that are homogenous with respect to relevant agronomic factors, identifying all relevant data elements, the bulk of which are agronomic in nature, defining the boundaries of the management zones with GPS coordinates, and associating the relevant data elements with their respective GPS coordinates in a GIS record. The system may be used to determine the carbon sequestering capacity of a field, and to assist in accumulating and verifying carbon credits. These components are described in more detail below.

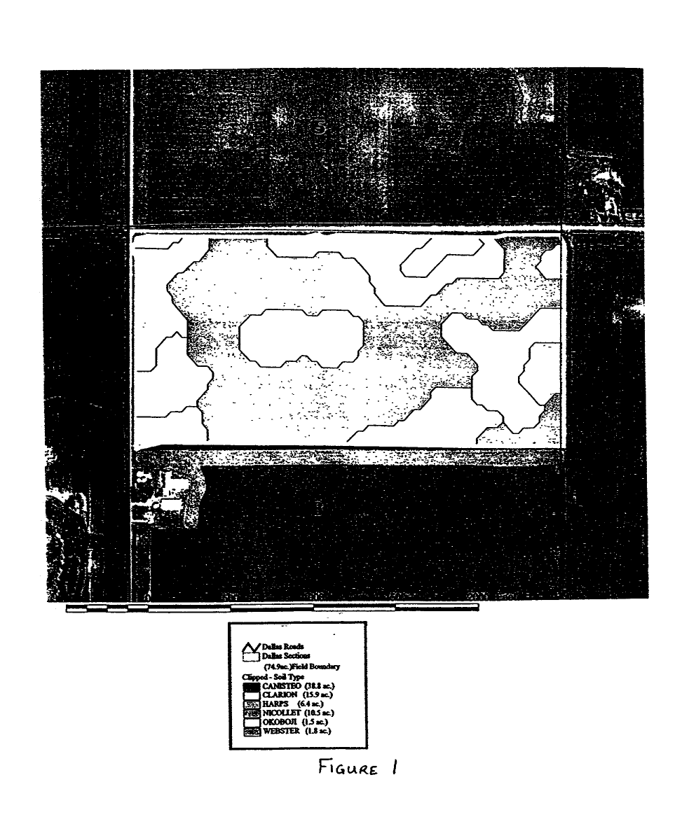

The use of GPS technology in mapping farms is a well-known practice. For the purposes of the present invention a map is needed that identifies the location of features that are important to the characteristics of the underlying soil. In order to create this map, the land being insured may surveyed using a GPS receiver. Typically this will involve using a GPS receiver and recording device to get a map of the boundaries of that parcel of land; however, in some instances it may be possible to convert the township-range-section information into GPS coordinates without performing a physical survey of the parcel of land. Then, either individual soil test data or publicly available soil type data is incorporated into the map. Soil-type maps are commonly available that show the location of various soil types within a parcel of land. The GPS coordinates relating to these soil types can be entered into the overall map of the parcel by either physical inspection of the parcel and use of a GPS receiver and recording device, or by directly converting the information from the soil-type maps into GPS coordinates. FIG. 1 shows a map of a field that shows the types of soil contained in the field. The field may also be surveyed for major features such as waterways, terraces and fencelines using a GPS receiver and recorder. Using this agronomic information relating to soil types and major geographic features, the field can be divided into management zones.

The present system has been designed for use with the existing GPS satellites placed in orbit and controlled by the United States Government. However the term GPS should be interpreted to include any similar future systems that might be developed.

Preferably the fields will be divided into management zones along the boundaries of the various soil types. Some soil types have very similar risk characteristics and can be included in the same management zone if they adjoin each other.

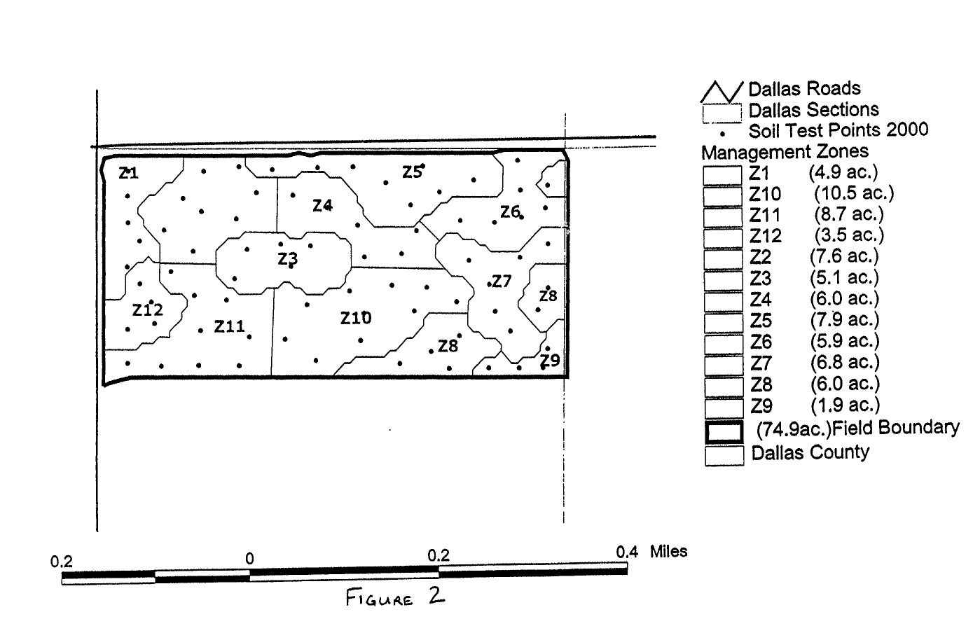

FIG. 2 shows a map divided into management zones that a farmer, or insurance agent working with a farmer, can use in obtaining the necessary information from the farmer. Preferably this map will be used with an interactive computer input screen so that farmer can just point a curser at the intended zone to select it. The farmer is requested to input for each management zone what, if any, crops he intends to plant within that management zone, and what if any carbon credit creating activities he intends to perform with respect to that management zone. It is expected that this will be accomplished with a graphic user interface.

Each management zone is a polygon defined by line segments joining GPS coordinates on its boundary. Each of these management zones has a separate record in a Geographic Information System (GIS). The preferred GIS is a form of a searchable data base that is adapted to handle GPS information. Each record in the GIS data base has several fields of information associated with the management zone. These fields of information permit an insurance provider to track information related to each management zone. The preferred GIS is a modified version of a data base sold under the trade name ArcView and manufactured by Esri Inc. Those of ordinary skill in the art should be aware of other data bases that can be adapted to handle GPS information.

The preferred fields at a minimum will track the carbon creating activities intended to be performed in the management zones. Additional agronomic information may also be included in the fields, such as samplings of the pH levels of management zones, the timing and amount of fertilizer applied within each management zone, the timing of planting and emergence within each management zone, the average cation exchange capacity of the soil in the management zone, the moisture capacity of the soil, and numerous other agronomic characteristics of which those of ordinary skill in the art will be aware.

As an additional benefit for the system, the same information that is useful in assessing and reducing the risk of crop failure, is also useful in verifying carbon credits. Furthermore, the system of insurance agents and relationships with farmers that results from providing crop insurance is useful in accumulating carbon credits.

One carbon credit is the atmospheric warming equivalent of one metric ton of carbon dioxide NOT released into the atmosphere. The soil can be a large repository for storing carbon dioxide and organic carbon. The type of crop and the livestock management practices a producer uses can have a tremendous impact upon the amount of carbon stored in the soil. A carbon credit can be defined by GPS designation to provide an auditable legal location in all environments.

Plants convert atmospheric carbon dioxide into sugars and other carbon compounds in the process of growth. When a plant dies, some of the carbon dioxide it has absorbed remains as organic carbon in the form of dead roots and stalks buried in the soil. As plant material decays, carbon dioxide is released back into the atmosphere. The plant residue, (i.e., roots, stems, leaves) first break down into humus, provided the breakdown occurs in an aerobic situation. Tillage accelerates oxidation and mineralization of humus back into carbon dioxide and the other minerals it contained. By reducing tillage, the farmer reduces oxidation and mineralization rate of soil humus into carbon dioxide. The rate of crop residue breakdown and movement of atmospheric carbon dioxide into soil humus may or may not be affected by tillage, but if it is, the effect is probably minimal. The benefit of these practices is that they reduce the rate that the carbon dioxide is lost from the soil back to the atmosphere, while maintaining a constant rate of accumulation, leading to a net increase in soil carbon, and a net decrease in atmospheric carbon. Since conventional tillage and erosion accelerate plant decomposition, efforts to reduce soil tillage and erosion help increase the amount of organic carbon retained or sequestered in the soil. Reduced tillage also effects the amount of organic matter and moisture retained in the soil, which could have an impact to reduce crop losses in a dry year. A carbon credit program is environmentally friendly because it reduces harmful greenhouse gas emissions into the atmosphere, but it also reduces agricultural risk by increasing the fertility of the soil and helping to control erosion of the land.

carbon credits are created by a change in practice or management that avoids the emission of greenhouse gases. In order to qualify as a reduction, the activity must subtract or offset emissions from a predetermined baseline. While all green plants absorb carbon dioxide and create biomass, a net addition to stored carbon is not automatic. For example, warmer, southern soils have higher microbial activity that metabolizes most or all of the organic carbon created in a growing season even with minimum tillage. Without some management change or practice change, some activities that sequester carbon are already included in the baseline calculations (e.g. existing unmanaged forests and pastureland).

Common practices that may create carbon credits in many soils and locations are: minimum and no-till tillage practices, cropland retirement, nitrogen fertilizer reduction, use of livestock manure for fertilizer and reforestation. carbon credits may also be created by reducing fossil fuel usage.

The USDA's Natural Resource Conservation Service (NRCS) and several environmental engineering firms are developing Carbon Credit protocols for these practices. Protocols define how carbon credits are to be measured and calculated. The marketplace must generally accept Carbon Credit protocols for the carbon credits to have value.

Companies and consumers will buy Carbon Credits because they need or want to reduce their emissions but find it more cost effective to buy offsets rather than change their already established practices.

At the present time there are two matrices in development for the establishment of carbon credits for various practices, soil conditions, and weather environments. The information gathered for the system described above relative to assessing and reducing crop failure risks can be used to calculate carbon credits. The two matrices developed are CQESTER and C-STORE.

The CQUESTR model was developed by NRCS. According the CQUESTR model, the carbon credit storage capacity of a given piece of land is defined according the following Model Equation: Rr=Ir×exp(k×fN×fW×fB×CDD)

Rr=Residue remaining storage capacity

Ir=Initial residue

k=Decomposition coefficient

fN=Nitrogen content factor

fW=Water factor

fB=Biomass type factor

CDD=Cumulative Degree Days

The C-STORE matrix provides an interface between complex research models and user capability. This model calculates soil organic matter changes based on their inputs. The model uses similar inputs to the CQUESTR model. Both models are expected to be available in PC software applications that would permit the transfer of data from the GIS records being developed in this proposed invention directly into the matrices for a determination of the available carbon credits.

In order for carbon credits to be a viable commodity, there must be some way of verifying that carbon credits for any given parcel of land have only been sold once. The GPS boundaries created for the management zones provide a global identifier for each management zone. GIS software permits a determination of whether any point or group of points is contained within a specified management zones. Therefore, as carbon credits are sold for a management zone, an indication is made in the GIS information that that management zone has had its carbon credits sold. If a certifying agency wishes to determine whether the carbon credits for a particular location have been sold, a search can be formed in the GIS based on the GPS coordinates of the specified location to verify that its carbon credits have not been sold previously. Because GPS coordinates are global, they define the entire set carbon credits available to be sold with unique coordinates.

An additional requirement for the value of carbon credits based on carbon sequestering is verification that the agreed to practice is still being followed. For example, if a farmer agreed to convert to no-till practices in order to create carbon credits, there needs to be some way of verifying that the farmer is actually adhering to those practices on the specified land. The network of agents and information gathering personnel needed to collected the information for the fields of the GIS records can easily provide period confirmation that the agreed to practices are being adhered to. One of the fields of information associated with each management zone can be the type of tillage practice being used on the management zone. That would permit a simple verification that the land in question is being used according to the agreed to practices.

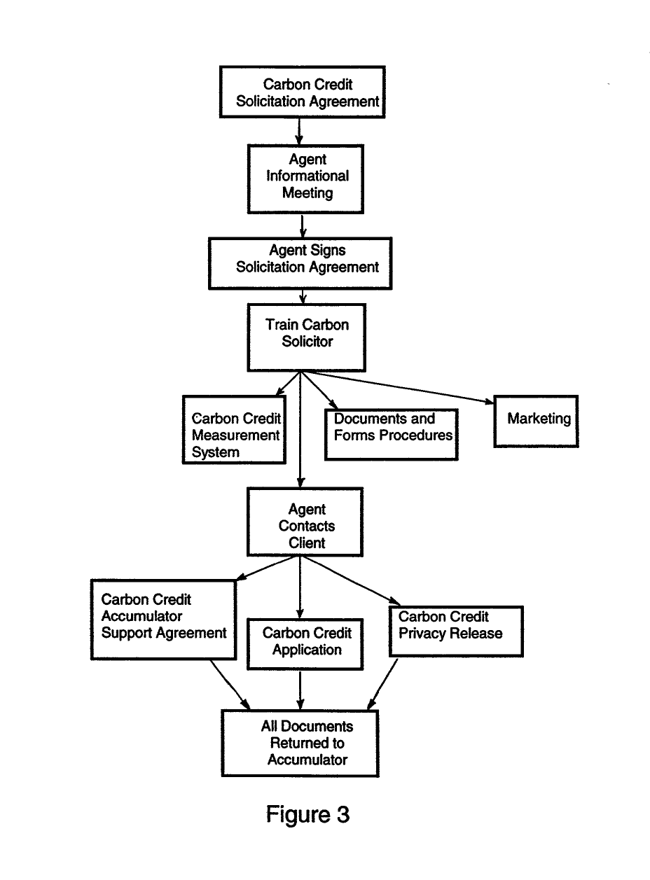

A preferred method of accumulating carbon credits for sale to third parties is outlined in the flow chart shown in FIG. 3. According to this method of accumulating carbon credits, the insurance provider would act as an accumulator, or holding agent, for carbon credits. The objective is to help producers document the number and source of their eligible carbon credits, and to provide a conduit for the sale of those carbon credits. While the preferred entity to be the accumulator is a crop insurance provider, the methods outlined herein could be used by any entity wishing to accumulate carbon credit data. The insurance provider, or other accumulator, would not buy the carbon credits or otherwise guarantee their value.

As seen in FIG. 3, the first step in the preferred process is to enlist agents who will solicit agreements with producers for the insurance provider, or other accumulator, to accumulate data related to carbon credits for the producer. Preferably the agent is already an agent that sells crop insurance for the insurance provider. Preferably a contract is signed between the agent and the accumulator that outlines the agents duties and responsibilities and provides for payment of a commission to the agent based on a percentage of the fees generated from the accumulating services. Training should be provided to the agents as to the concepts and principles involved in carbon credit establishment.

The agents will then solicit producers to sign-up acres of their agricultural land for participation in carbon credit creation. A standardized accumulator support agreement should be used by the agents to form a contract between the insurance provider and the producer. According to the terms of the accumulator support agreement, the producer requests that the insurance provider, or other accumulator, accumulate data for the purpose of formatting the data into the acceptable format necessary for establishment of carbon credits. The accumulator agrees to help in creating the documentation necessary to establish the carbon credits. The producer would be expected to pay a fee to the accumulator for these services. It may also be desirable to receive written permission from the producer to release the necessary information to the agents. All of the documents should then be returned to the accumulator.

An application for carbon credits can be used to gather the information necessary to create carbon credits. The final form of the application may depend on what protocols become established as the norm in the market. At a minimum it is expected the application for carbon credits would include the GPS information locating the underlying land, the name and address of the present land owner, and a description of the activity planned to reduce or sequester carbon emissions.

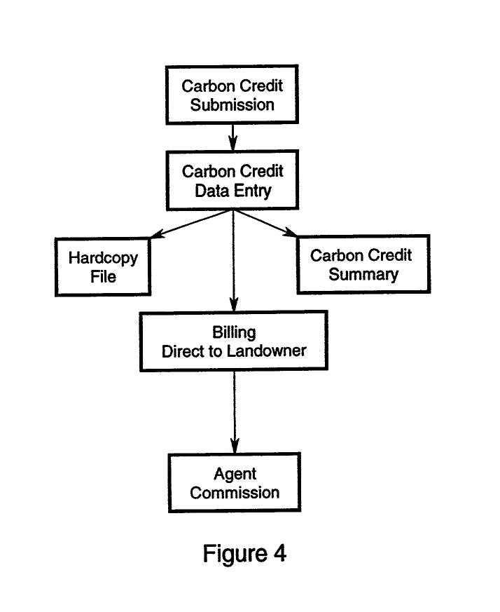

The preferred flow of documents in the carbon credit accumulation process is shown in FIG. 4. A carbon credit submission form would be submitted by the agent to the accumulator. This form may be the application referred to in the preceding paragraph, or it may be a separate form. In any event, the carbon credit submission form would contain sufficient information to permit the preparation of a Summary of Potential Emission Reduction Credit Form, as shown in FIG. 6. After the accumulator receives the carbon credit submission form, it creates the Summary shown in FIG. 6, and forwards a copy to the producer and the agent. The accumulator then bills the producer for the services in accumulating the data. After the producer pays the bill, the agent is paid a commission according to the terms of the agreement between the agent and the accumulator.

Outside entities wishing to verify the authenticity of a carbon credit could request an audit by the accumulator. The accumulator can review the fields of the GIS records to assure that the carbon credit in question is associated with only a single tract of land that is not associated with any other carbon credits. An agent of the accumulator can then inspect the land in question to verify that the agreed to practices for reducing emissions are being followed with respect to the relevant management zones. A record of the reviews can be provided to the party requesting the audit according to what ever standards the requesting party requires. A fee would be paid by the party requesting the audit to the accumulator for the verification process.

The invention claimed herein is not limited by the above description of the preferred embodiments. Those of ordinary skill in the art will recognize modifications to the preferred embodiments that remain within the scope of the invention. As such, the foregoing description should be considered illustrative rather than limiting. It is the following claims, including any equivalents thereof, which are intended to define the scope of the invention.

We claim:

1. A method of documenting a verifiable carbon credit comprising:
determining an amount of carbon credits created on a parcel of land;
defining a boundary for said parcel of land in terms of GPS coordinates; and
creating an electronic GIS record for said parcel of land that associates said amount of carbon credits created on said parcel of land with said GPS coordinates of said parcel of land.

2. A method of accumulating information needed to establish verifiable carbon credits comprising:
reaching an agreement with a landowner to accumulate data relevant to establishing a carbon credit for activities conducted on a parcel of land owned by said landowner;
defining a boundary for said parcel of land using GPS coordinates;
collecting data relevant to establishing a carbon credit;
creating a GIS record based on said GPS coordinates that are used to define said boundary, said GIS record including data fields for entry of data relevant to establishing a carbon credit; and
entering said collected data into said data fields such that said collected data is associated with said GPS coordinates that are used to define said boundary of said parcel of land, said association of said collected data with said GPS coordinates permitting verification of said carbon credits.

3. A method of verifying the existence of carbon credits associated with a specified parcel of land for a third party, the method comprising:
defining a boundary for the specified parcel of land using GPS coordinates;
maintaining a searchable database of carbon credits associated with GPS coordinates of a plurality of parcels of land on which said carbon credits were created; and
searching said searchable database to verify that said specified parcel of land does not contain any points that are contained within the boundaries of the plurality of parcels of land.

4. The method according to claim 3, further comprising inspecting said specified parcel of land to verify that activities conducted on said specified parcel of land will create the carbon credits.
